(19) United States
(12) Patent Application Publication
(10) Pub. No.: US 2010/0203339 A1
(43) Pub. Date: Aug. 12, 2010

(54) PLASMA TREATMENT OF CARBON-BASED MATERIALS AND COATINGS FOR IMPROVED FRICTION AND WEAR PROPERTIES

(76) Inventors: Osman Eryilmaz, Plainfield, IL (US); Ali Erdemir, Naperville, IL (US)

Correspondence Address: FOLEY & LARDNER LLP, 150 EAST GILMAN STREET, P.O. BOX 1497, MADISON, WI, 53701-1497, US

(21) Appl. No.: 12/684,477

(22) Filed: Jan. 8, 2010

Related U.S. Application Data
(60) Provisional application No. 61/150,564, filed on Feb. 6, 2009.

(51) Int. Cl. B32B 9/04; B05D 3/00

(52) U.S. Cl. 428/408; 427/535

(57) ABSTRACT

A method of plasma modification of a film includes applying about −400 V to about −600 V to a gas in a chamber to generate a gas-discharge plasma; and subjecting the film to the gas-discharge plasma to form a plasma-modified film, where the gas comprises H₂, H₂S, NH₃, deuterium, methane, or a mixture of any two or more. Films may be prepared. Devices coated with the films may be prepared.

### CROSS-REFERENCE TO RELATED APPLICATIONS

This application claims the benefit of U.S. Provisional Patent Application No. 61/150,564, filed Feb. 6, 2009, the entire contents of which are incorporated herein by reference, for any and all purposes.

### GOVERNMENT RIGHTS

The United States Government has rights in this invention pursuant to Agreement/Award Number DE-AC02-06CH11357 between the United States Department of Energy and UChicago Argonne, LLC.

### BACKGROUND

Carbon-based materials and coatings have been shown to have surface properties which are useful in tribological applications, and also in medical applications. For example, diamond-like carbon and carbon nitride coatings are used extensively on magnetic hard discs by the data storage industry to combat friction and wear as well as for the prevention or minimization of corrosion and oxidation. These coatings can provide low friction coefficients and high wear and corrosion resistance in magnetic hard discs when used in combination with a synthetic-base oil, such as Pennzane® (hydrocarbon-based lubricant, available from Nye Lubricants, Fairhaven, Mass.) or Z-dol® (perfluorohydrocarbon-based lubricant, available from Solvay, Thorofare, N.J.). Carbon-based coatings are also used in various manufacturing and transportation applications such as machining and metal forming tools, fuel injectors, gears, bearings and some of the power- and drive-train applications in automobiles.

Carbon-based coatings also present challenges for such applications. In the case of magnetic hard drives, the coatings must be thick enough to effectively cover the hard disc surface and hence prevent corrosive attack. To achieve this goal, currently, very thin layers of liquid lubricant are used in conjunction with the carbon coatings. However, liquid lubricants can cause other problems and eventually liquid lubricants can lose their lubricating properties due to thermal breakdown, bodying of the lubricant, or uneven distribution of the lubricant across a surface. Challenges also exist with regard to the production of very thin carbon coatings for hard discs. Such challenges include uniform coverage and minimization of pin hole formation. Further, without lubricant layers, the carbon coatings can wear rapidly. Similar problems and/or challenges exist in the case of carbon-based films used in metal-cutting or -forming tools. For example, such tools can quickly wear out, even with the use of the best metalworking fluids.

### SUMMARY

In one aspect, a method of forming a plasma-modified film is provided. Such methods include applying a voltage of about −400 V to about −600 V to a gas in a chamber to generate a gas-discharge plasma; and contacting a film with the gas-discharge plasma to form a plasma-modified film; where the gas includes H₂, D₂, HD, CD₄, CH₄₋ₙDₙ, H₂S, NH₃, H₂O, D₂O, HDO, or a mixture of any two or more such gases, where n is an integer from 1 to 4. In some embodiments, the film is a carbon-based film. As used herein “D” refers to deuterium, compounds such as HD and D₂ are deuterated and deuterium gases, and CH_{4-n′}D_{n′} is at least partially deuterated methane. In some embodiments, the gas includes H₂, H₂5, NH₃, CH₄, or a mixture of any two or more such gases. In some embodiments, the gas also includes Ar, He, Kr, CH₄, O₂, N₂O, NO₂, F₂, Cl₂, or a mixture of any two or more such gases. In some embodiments, the film is a carbon-based film. In other embodiments, the film is contacted with the gas-discharge plasma for about 1 second to about 20 minutes. In other embodiments, the voltage applied is about −500V.

In another aspect, the plasma-modified film prepared by the above method is provided. In some embodiments, the film, that is plasma-modified, is a carbon-based film; and the plasma-modified film includes H, N, S, D, or a mixture thereof, at, or near, a surface of the carbon-based film. In other embodiments, the thickness of a modified portion of the plasma-modified film is less than about 10% of an original thickness of the film.

The plasma-modified films exhibit marked reductions in friction when compared to the same film prior to plasma-modification. As such, in some embodiments, the plasma-modified film exhibits a reduction in friction of at least about 75% when compared to the film prior to modification.

Devices are also provided incorporating such plasma modified films. In some embodiments, a device includes a magnetic layer coated with a film that has been modified by the methods. In some embodiments, the device is an invasive or implantable medical device. As used herein, an invasive medical device is one that is inserted into, and removed from, a subject for conducting a procedure. Examples of invasive devices include, but are not limited to, catheters, drug-delivery devices, scalpels and other medical instruments, biopsy needles, and the like. Implantable medical devices are those devices that are inserted into a subject for an extended period of time. Examples of implantable devices include, but are not limited to, pacemakers, defibrillators, drug delivery implants, heart valves, stents, heart pumps, replacement orthopedic joints such as hips and knees, and the like.

In another aspect, a plasma-modified film prepared in a deuterium gas or deuterated methane hydrocarbon plasma is provided such that the film is deuterium rich. In some embodiments, the film includes a carbon film that is deuterium rich near the surface of the film.

### BRIEF DESCRIPTION OF THE DRAWINGS

FIG. 1 is a graph illustrating the friction and wear performance of a carbonitride film (CNx) before and after plasma treatment, in the wear test described in Example 1.

FIGS. 2A and 2C are photographs of the wear on an untreated, coated ball and a disk, respectively, from Group I as described in Example 1. FIGS. 2B and 2D are surface mapping graphical representations of the same ball and disk shown in FIGS. 2A and 2C, respectively.

FIG. 3A is a photograph of the wear on a treated ball from Group II as described in Example 1. FIG. 3B is a surface mapping graphical representation of the same ball.

FIG. 4 is a graph illustrating the friction and wear performance of carbon film coated steel balls before (Group III) and after (Group IV) plasma modification with hydrogen gas, as illustrated in Example 2.

FIG. 5 is a surface mapping graphical representations of a Group III ball, as in FIG. 4, in three dimensions, after 10 m of wear testing as in Example 2.

FIG. 6 is a surface mapping graphical representation of a hydrogen treated ball from Group IV, as in FIG. 4, in three dimensions, after 450 m of wear testing as in Example 2.

FIG. 7A is a three dimensional, ToF SIMS (Time of Flight Secondary Ion Mass Spectroscopy) mapping of a hydrogen-treated (darker shading is H) and an untreated (medium shading), coated flat surface, according to some embodiments. FIG. 7B is a two dimensional ToF SIMS mapping of a hydrogen-treated and untreated coated flat surface (disk).

FIG. 8 is a graph illustrating the friction and wear performance of a carbon film prepared in a deuterium-containing hydrocarbon plasma, according to some embodiments.

FIGS. 9A and B are surface mapping illustrations of the ball (A) and disk (B) samples of FIG. 8, after performance testing. The scale in FIG. 9A is 40 μm and the scale in FIG. 9B is 70 μm.

FIG. 10 is a graph illustrating how a deuterium gas environment lowers friction of a hydrogen-free, diamond-like carbon (DLC) film, and the intensity of load used (2 Newtons (N)) according to some embodiments.

FIG. 11 is a TOF-SIMS mapping of the sliding surfaces of hydrogen-free DLC tested in deuterium gas, according to some embodiments.

### DETAILED DESCRIPTION

In one aspect, methods for improving the friction and wear behavior of carbon-based materials and coatings are provided. In general, the methods involve plasma treatment of carbon-containing surfaces and films. More specifically, the methods relate to improvements in the tribological properties of carbon-based coatings such as diamond, diamond-like carbon, carbon nitride(s), carbon boride(s); and bulk carbon materials such as glassy carbon, graphite, carbon-carbon composite, metal carbides, etc. In some embodiments, the carbon-based coating is a carbon nitride of formula CNx, where x represents the fraction or proportion of nitrogen in the network of CN. While the magnitude of x may be known for some specific examples, x it typically variable, ranging from 0.01 to 1. Such materials and coatings may be used in many applications ranging from magnetic devices such as the discs in magnetic hard drives to rotating mechanical seals to heart valves and various medical implants.

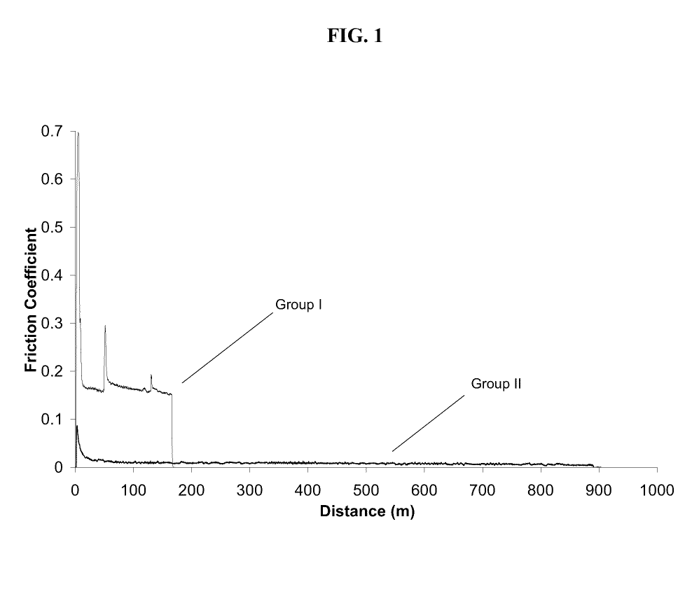

In some embodiments, the methods include the use of a gas discharge plasma to convert higher-friction carbon materials, coatings, and films to those having lower friction. FIG. 1 illustrates such reductions in friction. In FIG. 1, a relatively high-friction carbon nitride film is converted (modified) to a low-friction, low-wear carbon film. The carbon coating in FIG. 1 was subjected to a gas discharge plasma of Ar and H₂. However, a wider variety of gases may be used for plasma formation. In some embodiments, the plasma is formed from H₂, D₂, HD, CD₄, CH₄₋ₙDₙ, CH₄, He, Ar, Kr, O₂, N₂0, NO₂, Cl₂, H₂S, NH₃, H₂O, D₂O, HDO or a mixture of any two or more such gases, where n is an integer from 1 to 4. In other embodiments, the plasma is formed from H₂S, NH₃, or a mixture of such gases. In other embodiments, the plasma is formed from H₂, D₂, HD, CH₄₋ₙDₙ, H₂S, NH₃, H₂O, D₂O, HDO, or a mixture of any two or more such gases, where n is an integer from 1 to 4. In other embodiments, the plasma is formed from H₂, H₂S, NH₃, or a mixture of any two or more such gases. In other embodiments, the plasma is formed from H₂, D₂, or HD. In other embodiments, the plasma is formed from H₂S. In other embodiments, the plasma is formed from NH₃. In other embodiments, the plasma is formed from Ar, He, Kr, CH₄, O₂, N₂O, NO₂, F₂, Cl₂, or a mixture of any two or more such gases. As used herein, D₂ is deuterium gas, HD is a mixed hydrogen-deuterium gas, D₂O is deuterium oxide (“heavy water”), and HDO is a mixed hydrogen-deuterium water.

In some embodiments, the modification is conducted in a chamber with plasma contact. The plasma is generated by the application of a voltage from about −400 V (volts) to about −600 V, in some embodiments. In other embodiments, the plasma is generated from about −400 V to about −500 V. In yet other embodiments, the plasma is generated at about −500 V. Thus, the methods may include subjecting a device, having a carbon coating, to a plasma generated at the designated voltage, where the plasma includes He, Kr, O₂, N₂O, NO₂, Cl₂, H₂S, NH₃, H₂O, deuterium. In some embodiments, the plasma includes H₂, Ar, H₂S, NH₃, or a mixture of two or more such gases. The energy applied to generate the plasma may be pulsed D.C. (direct current), r.f. (radio frequency), or microwave.

In the methods of modification, the pressure of the gas that produces the plasma may be varied. Higher pressures are typically used. For example, the gas pressure may vary from about 20×10⁻³ Torr to about 50×10³ Torr, in some embodiments. In other embodiments the gas pressure is from about 20×10⁻³ Torr to about 45×10-³ Torr, from about 20×10⁻³ Torr to about 40×10³ Torr, from about 20×10⁻³ Torr to about 30×10-³ Torr, or from about 25×10⁻³ Torr to about 30×10⁻³ Torr. Higher gas pressures ranging from tens of Torr to atmospheric or even pressurized gases, of the kinds mentioned above, may be used in the sealed test environment without the need for external plasmas. In these cases, the surfaces of the carbon films to be modified are covered by the specific gases that are present in the gas, and they behave in a similar fashion as those of plasma-treated surfaces.

In other embodiments, an atmospheric pressure plasma generator may also be used to prepare the modified films of a carbon-film coated device as the device is functioning. For example, the functioning device may be enclosed within an atmospheric pressure plasma chamber. The plasma generator is then activated as needed to modify the sliding, rolling, or rotating surfaces of the operating device to achieve and maintain low friction and wear. The chamber may be filled with H₂, D₂, H₂S, NH₃, CH₄, CD₄, or other gases as described above, to self-deposit or terminate the sliding surfaces of mechanical devices operating in the sealed environment.

The plasmas are typically applied for a limited duration, although such duration is variable depending upon the given substrate or film. For example, the film is subjected to the gas-discharge plasma for about 1 second to about 10 seconds, according to some embodiments. In other embodiments, the film is subjected to the gas-discharge plasma for about 1 second to about 6 seconds. In other embodiments, the film is subjected to the gas-discharge plasma for about 5 seconds to about 6 seconds. However, the time that the film is subjected to the gas-discharge plasma is also contingent, in part, upon the size of the plasma chamber in which the modification is conducted. In larger chambers, the time period is increased, and may range from 5 to 20 minutes in some embodiments, from 5 to 10 minutes in other embodiments, or from 10 to 20 minutes in yet other embodiments.

Without being bound by theory, during such plasma treatment, the near surface chemistry of carbon films is converted to have copious amounts of H, F, O, Cl, N, and/or S at, or near, the surface of the carbon-based coating, where much of the friction and wear events occur. In other embodiments, the near surface chemistry of carbon films has copious amounts of H, N, and/or S. Such plasma-converted surfaces may exhibit other unique properties such as improved biocompatibility, catalytic effects, optical properties, and dielectric properties. For example, in magnetic recording, the modification of conventionally prepared CNₓ, or other carbon films, by the present methods, may enable magnetic hard discs to run dry (i.e. without liquid lubricant) under contact sliding conditions. Such an application was previously thought to be rather difficult, if not impossible, due to problems with high wear resulting from friction. In medical applications (such as heart stents, orthopedic implants and other types of invasive and implantable medical devices), such treatments can dramatically improve the bioreactivity and/or biocompatibility of such devices. Depending on the type of plasma treatment, the surface dielectric properties of carbon films can be modified or manipulated to a desired range. Optical reflectivity and/or transparency of carbon films can also be modified by such treatments, and these may have significant implications for the performance of vision devices, solar cells, and the like.

Films treated with the plasmas exhibit a surface modification due to the plasma treatment, with only the outer most portions of the thickness of the film (i.e. the near surface) being modified. While the thickness depends on the gas used in the plasma modification process and the length of time a film is subjected to modification, in some embodiments, a modified layer thickness can be in the range of from about 1 nm (nanometers) to about 30 nm, from about 1 nm to about 20 nm, or from about 1 nm to about 10 nm. Thicker films can be thinned by the current process to achieve very thin films down to less than 50 Å (angstroms), in some embodiments. As used herein, the “thinning” of a film refers to carbon sputtering from a thicker carbon film in the plasma, typically one mono-layer at a time, According to other embodiments, the films may be thinned down to from about 2 Å to about 50 Å, from about 2 Å to about 40 Å, from about 2 Å to about 30 Å, from about 2 Å to about 20 Å, from about 2 Å to about 15 Å, from about 2 Å to about 10 Å, from about 2 Å to about 5 Å, or from about 3 Å to about 5 Å. Such thinned films can be well suited to applications where carbon film thickness is critical to device functionality. For example, thin carbon films are desirable in magnetic recording media where carbon film thickness is critical for device functionality and recording capacity. This is especially important if continuous films are not achievable by deposition only. In such cases, plasma modification processes can be used to thin the continuous, but thicker film in desired low thickness homogenously. Such processes can be used to prepare very thin continuous films. The portion of the original thickness of the film that is modified is less than about 10%, according to some embodiments. In other embodiments, the modified portion is limited to from 0.1% to about 10%. In yet other embodiments, the modified portion is limited to from about 0.1% to about 9%, from about 0.1% to 8%, from about 0.1% to about 7%, from about 0.1% to about 6%, from about 0.1% to about 5%, from about 1% to about 10%, from about 1% to about 9%, from about 1% to about 8%, from about 1% to about 7%, from about 1% to about 6%, or from about 1% to about 5% of the original thickness of the film.

When such plasma-treated (i.e. modified) carbon films are used in devices, superior performance and durability can also be achieved, due in part, to the significant reductions in friction imparted by the modification process. For example, in some embodiments, friction of a treated film is reduced by at least about 75% when compared to a film that has not been treated. In other embodiments, friction of a treated film is reduced by at least about 80% when compared to a film that has not been treated. In other embodiments, friction of a treated film is reduced by at least about 85% when compared to a film that has not been treated. In other embodiments, friction of a treated film is reduced by at least about 90% when compared to a film that has not been treated. In other embodiments, friction of a treated film is reduced by at least about 95% when compared to a film that has not been treated. The plasma modification methods result in dramatic improvements in wear resistance of carbon films. For example, without hydrogen plasma treatment, an amorphous carbon nitride film having a thickness of about 200 nm, has a wear about 4.06×10⁻⁷ mm³/N·m. After plasma modification with H₂, the wear rate is reduced to 1.68×10⁻⁹ mm³/N·m, an improvement by more than 240 times.

In some embodiments, the plasma-treated carbon film is prepared in a deuterium gas, or deuterated methane hydrocarbon plasma, such that the resulting film is deuterium-rich. As the films are generally prepared on the surface of the carbon film, it includes a deuterium-rich phase near the surface of the film. While hydrogen and deuterium are electronically similar, the size differences are significant, with deuterium being of a larger size and of a higher molecular weight than hydrogen. Without being bound to theory, it is believed that because of its larger size, deuterium may provide better protection against corrosion and wear when forming a deuterium-rich phase, or layer, on the carbon film.

Methods of modifying a device with plasma contact are also provided. In some embodiments, the modification of the device is conducted in a chamber with plasma contact. In other embodiments the device is first coated with a film, which is then subjected to the plasma treatment. In other embodiments, the film is first subjected to the plasma modification and the film is then applied to a device.

The devices used in the methods of modification may also be coated with layers of materials, or films. For example, a substrate may be coated with a first layer. The first layer may then be coated with a CNx film, followed by modification. In some embodiments, the first layer is a magnetic layer. In other embodiments, first layer is a bond layer. As used herein, a bond layer is a layer of a metal, in some cases a transition metal, or a carbide of a metal, that provides a bonding surface between a substrate and a carbon film.

The present methods also allow for modification of the film, after deposition and exposure to an outside atmosphere, according to some embodiments. For example, special handling of films prior to plasma modification is not necessary. As such, a device with an applied film may be exposed to air or other typically detrimental environments, yet then be subjected to the plasma modification methods while maintaining the benefits of the plasma treatment.

The plasma-treated films may be used in a variety of medical, manufacturing, and transportation applications. For example, the films may be used in machining and metal forming tools, fuel injectors, gears, bearings, power-trains, drive-trains, and medical devices, as well as a host of other applications.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, the terms “tribology,” and “tribological” refer to the science and technology of interacting surfaces in relative motion. The terms include the study and application of the principles of friction, lubrication , wear, and other effects, and the results of those effects on various parts and components subject to friction, lubrication, wear, and such other effects.

The embodiments illustratively described herein may suitably be practiced in the absence of any element or elements, limitation or limitations, not specifically disclosed herein. Thus, for example, the terms “comprising,” “including,” “includes,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Additionally the phrase “consisting essentially of” will be understood to include those elements specifically recited and those additional elements that do not materially affect the basic and novel characteristics of the claimed invention. The phrase “consisting of” excludes any element not specifically specified.

One skilled in the art will readily realize that all ranges discussed can and do necessarily also describe all subranges therein for all purposes and that all such subranges also form part and parcel of this invention. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present invention, thus generally described, will be understood more readily by reference to the following examples, which are provided by way of illustration and are not intended to be limiting of the present invention.

### Examples

### Example 1

Steel balls (AISI 52100) were coated with carbon nitride, CNx, to form a material referred to as Group 1 (initial diameter of 23.5 mm). Some of the balls were then subjected to a plasma atmosphere of Ar and H₂ for 5 minutes, at −500 V (r.f. or pulsed), to form a material referred to as Group II (initial diameter 45 mm). The Group I and II balls were then subjected to a wear test under a nitrogen atmosphere with a load of 1 N, and at a speed of 100 rpm. These tests were performed on a pin-on-disk machine whose function and main features may be found in the 1990 Annual Book of ASTM Standards, Volume 3.02, Section 3, pages 391-395. The wear rates shown in the diagrams were calculated from a formula given in the same book of ASTM Standards. In this machine, the ball is held stationary under the applied load against the rotating disk. During sliding, a flattened wear scar forms on the ball's contact spot and the diameter of this wear scar is measured under a microscope and then converted to a wear volume and eventually to a wear rate as described in the ASTM Standards mentioned.

The Group I balls exhibited a ball wear volume of 6.91×10⁻⁵ mm³ and a ball wear rate of 4.06×10⁻⁷ mm³/N·m. The Group II balls exhibited a ball wear volume of 1.52×10⁻⁶ mm³ and a ball wear rate of 1.68×10⁻⁹ mm³/N·m. The measured wear volume or rate is an indication of the wear resistance of the test material or coating being rubbed in the test system. As such, the results show a significant reduction in overall wear from the Group I to Group II balls. The results are presented graphically as FIG. 1. As shown, the Group I balls showed a much larger initial friction coefficient and failure occurred at a distance of approximately 175 m. The modified Group II balls show a lower initial friction coefficient that levels off quickly and continues before failure at approximately 890 m. The friction is reduced by more than 95%, with it being nearly 30 times lower in the case of the plasma treated CNx. The wear has been reduced by more than 1000 times as compared to an untreated ball.

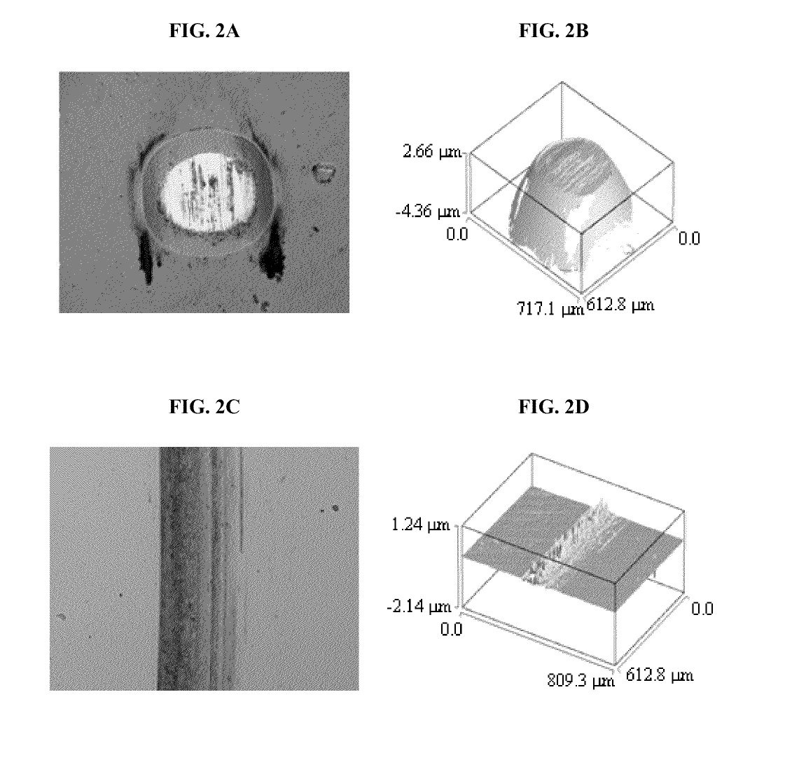

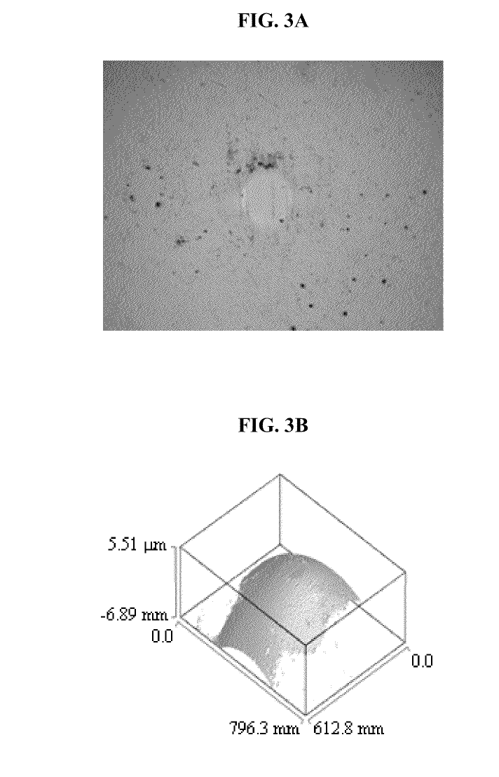

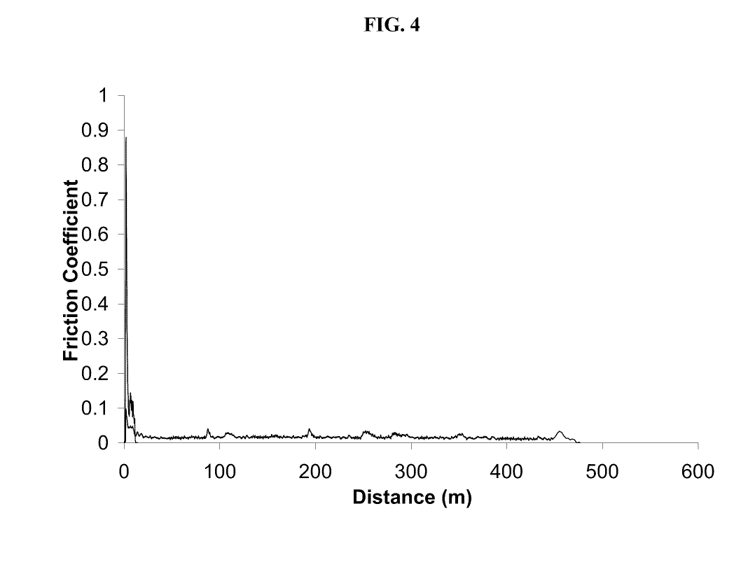

Photographs of a Group I ball, FIGS. 2A, in comparison to the Group II ball, FIG. 3A, show physical differences in wear patterns. The Group I balls show an obvious wear line in the disk (FIG. 2C) and flattening of the surface of the ball (FIG. 2A). In comparison, the modified Group II balls fail to show visible signs of wear, although surface mapping indicates some wear was present. FIGS. 2B and 2D are surface mapping representations of the Group I ball and disk, respectively, after testing, and FIG. 3B is a surface mapping representation of the Group II ball, after testing.

Raman spectra of unmodified CNx films and modified CNx indicate that the modification is limited to a top surface layer of the CNx film. The Raman spectrum for unmodified and modified CNx films are indistinguishable.

### Example 2

Steel balls (AISI 52100) were coated with amorphous carbon to form a material referred to as Group III. Some of the balls were then subjected to a plasma atmosphere of H₂ for 5 minutes, at −500 V (r.f. or pulsed), to form a material referred to as Group IV. The Group III and the Group IV balls were then subjected to a wear test under a nitrogen atmosphere with a load of 0.5 N, and at a speed of 100 rpm in a dry nitrogen atmosphere. The wear tests were performed on a pin-on-disk machine as described above for Example 1. In the pin-on-disk machine, the ball is held stationary under the applied load against the rotating disk.

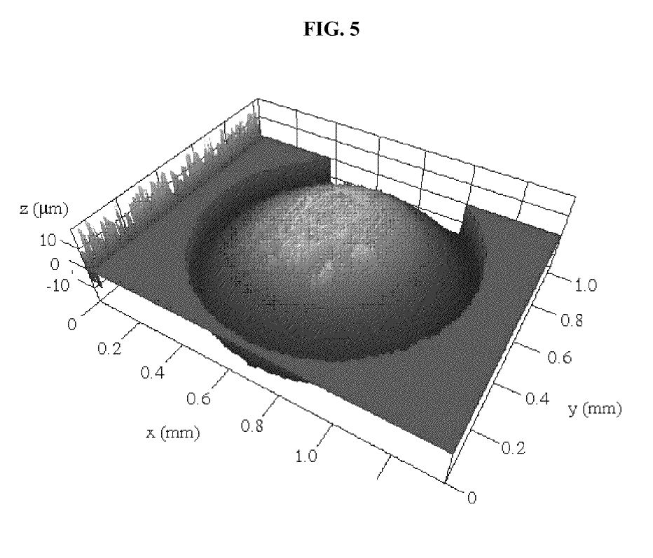

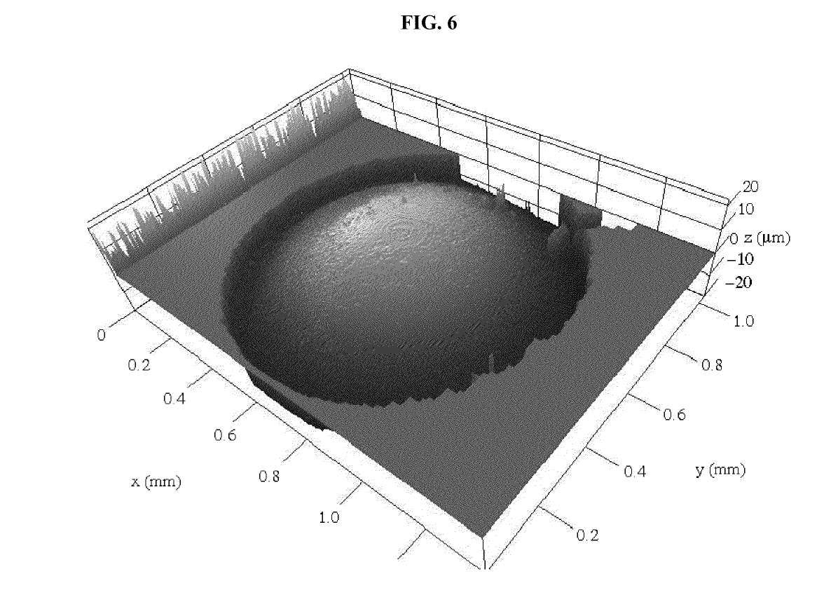

The wear track (WT) diameters of the as-received, and of the hydrogen plasma treated amorphous carbon films were 20 mm. As received, the Group III balls wore out after about 10 m of sliding distance, as shown in FIG. 4. The friction coefficient of the Group III balls was also very high, with at least one reading as high as 0.8. FIG. 5 shows the condition of the wear scar on the ball surface after about 10 m of sliding, further confirming that the carbon film was indeed worn out, the wear scar was rather large, and the substrate steel was exposed. The Group IV balls exhibited a much improved wear life as shown in FIG. 6. Even after 450 m of sliding, the friction coefficient remained very low and the wear scar on the ball side was very small (see FIG. 6).

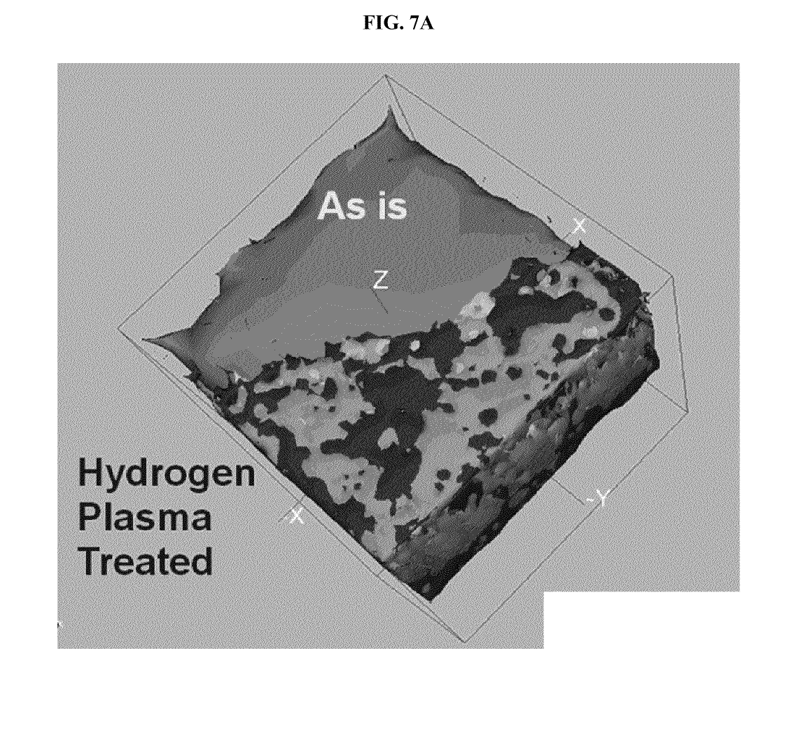

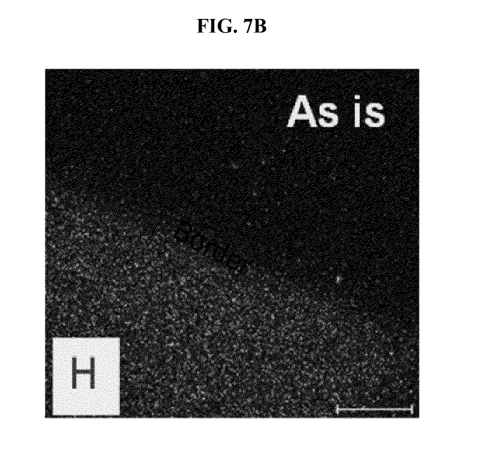

Secondary ion mass spectroscopy of a boundary region of the carbon film surface was conducted on both the unmodified and the hydrogen plasma modified regions. Both treated and untreated flat disk samples are shown in FIG. 7A, in a three dimensional image, and in FIG. 7B, in a two dimensional image. In FIG. 7A the boundary region is clearly shown by the textural change, and the boundary region in FIG. 7B, while showing a textural change as well, also is designated with the word “border.” As shown in FIGS. 7A and 7B, the hydrogen treated region is very different and very rich in hydrogen, as compared to the un-treated region where little or no hydrogen is found. The hydrogen plasma treatment of carbon film results in a hydrogen-rich top surface exhibiting much-improved friction and wear properties. FIGS. 7A and 7B are also known as ToF SIMS mapping diagrams.

### Example 3

Steel balls (AISI 52100) were coated with deuterium-rich amorphous carbon films and subjected to tribological tests under a nitrogen atmosphere with a load of 5 N, and at a speed of 119 rpm in a dry nitrogen atmosphere. The wear tests were performed on a pin-on-disk machine as described above for Example 1. In the pin-on-disk machine, the ball is held stationary under the applied load against the rotating disk.

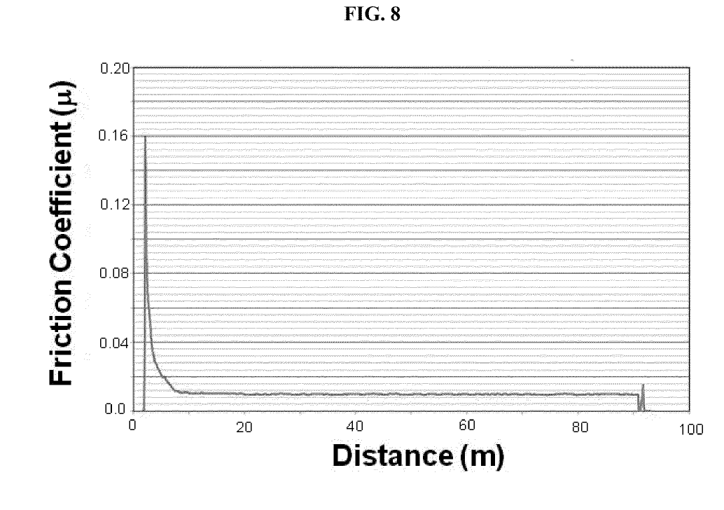

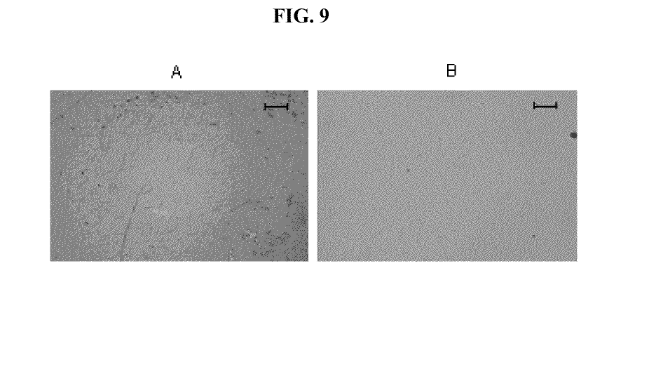

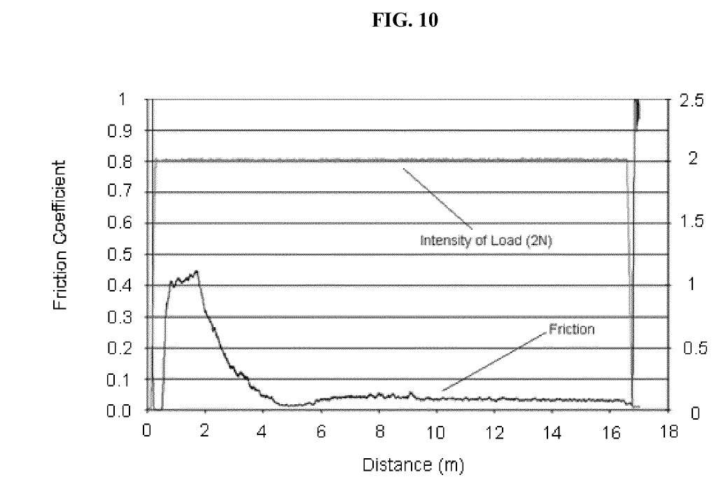

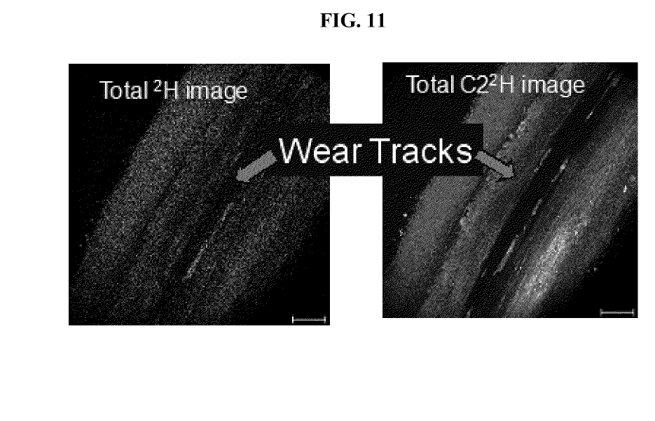

The friction coefficient of the deuterium-rich carbon film coated balls was 0.015 as shown in FIG. 8. The parameters of the testing for FIG. 8, included 5N load, 119 rpm, on an 8 mm track diameter under a nitrogen atmosphere. FIG. 9 illustrates the condition of the wear scar on the ball surface (9A) and wear track on the disk surface (9B) after about 90 m of sliding, further confirming that the carbon film was very resistant against wear. In fact, the location of wear scar and track was very hard to discern. FIG. 10 is a graph illustrating how a deuterium gas environment lowers friction of a hydrogen-free, diamond-like carbon (DLC) film. FIG. 11 is a TOF-SIMS mapping of the sliding surfaces of hydrogen-free DLC film after testing in deuterium. From these figures, it is clear that the deuterium gas results in the formation of a deuterium-rich top surface exhibiting much-improved friction and wear properties.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method of preparing a plasma-modified film comprising:
applying a voltage of about −400 V to about −600 V to a gas in a chamber to generate a gas-discharge plasma; and
contacting a film with the gas-discharge plasma to form the plasma-modified film;
wherein:
the gas comprises H₂, D₂, HD, CH₄₋ₙDₙ, H₂S, NH₃, H₂O, D₂O, HDO, or a mixture of any two or more thereof; and
n is an integer from 1 to 4.

2. The method of claim 1, wherein the film is a carbon-based film.

3. The method of claim 2, wherein the carbon-based film is diamond, diamond-like carbon, carbon nitride(s), carbon boride(s); glassy carbon, graphite, a carbon-carbon composite, a metal carbides, or a mixture of any two or more thereof.

4. The method of claim 2, wherein the carbon-based film is a carbon nitride of formula CNx, wherein x represents a network of CN units.

5. The method of claim 1, wherein the film is contacted with the gas-discharge plasma for about 1 second to about 20 minutes.

6. The method of claim 1, wherein the applied voltage is about −500V.

7. The method of claim 1, wherein the gas is at a pressure of about 20×10⁻³ Torr to about 50×10³ Torr.

8. The method of claim 1, wherein the gas comprises H₂, H₂S, NH₃, or a mixture of any two or more thereof.

9. The method of claim 1, wherein the gas comprises H₂, D₂, or HD.

10. The method of claim 1, wherein the gas comprises H₂S.

11. The method of claim 1, wherein the gas comprises NH₃.

12. The method of claim 1, wherein the gas further comprises an inert gas.

13. The method of claim 12, wherein the inert gas is He, Ar, or Kr, or a mixture of any two or more thereof.

14. The method of claim 1, wherein the gas further comprises Ar, He, Kr, CH₄, O₂, N₂O, NO₂, F₂, Cl₂, or a mixture of any two or more thereof.

15. The method of claim 1, further comprising exposing the film to air, oxygen, moisture, or a mixture of any two or more thereof, prior to subjecting the film to the gas-discharge plasma.

16. The plasma-modified film prepared by the method of claim 1.

17. The plasma-modified film of claim 16, wherein
the film is a carbon-based film; and
the plasma-modified film comprises H, N, S, deuterium, or a mixture of any two or more thereof, at, or near, a surface of the carbon-based film.

18. The plasma-modified film of claim 16, wherein a thickness of a modified portion of the plasma-modified film is less than about 10% of an original thickness of the film.

19. The plasma-modified film of claim 16, wherein the plasma-modified film exhibits a reduction in friction of at least about 75% when compared to the film.

20. A device comprising a magnetic layer coated with a film that has been modified by the method of claim 1.

21. The device of claim 20, wherein the film is a CNₓ or a hydrogen-free carbon film.

22. The device of claim 20, wherein the device is a medical device.

23. The device of claim 22, wherein the medical device is a medical implant.
